(19) United States
(12) Patent Application Publication
(10) Pub. No.: US 2020/0151977 A1
(43) Pub. Date: May 14, 2020

(54) Secure Video Doorbell Visitor Filtration System and Method of Operation

(71) Applicants: Tijmen Vos, Amsterdam (NL); Zeynep Yurdakul, Amsterdam (NL); Bernard Maassen, Amsterdam (NL); Wouter Lauret, Amsterdam (NL)

(72) Inventors: Tijmen Vos, Amsterdam (NL); Zeynep Yurdakul, Amsterdam (NL); Bernard Maassen, Amsterdam (NL); Wouter Lauret, Amsterdam (NL)

(21) Appl. No.: 16/186,659

(22) Filed: Nov. 12, 2018

(51) Int. Cl. G07C 9/00; H04N 7/18; G08B 13/196

(52) U.S. Cl. CPC G07C 9/00309; H04N 7/186; G07C 9/00071; G07C 2009/00412; G08B 13/196; G07C 2009/0042; G07C 9/00111

(57) ABSTRACT

A system uses a visitor filtration apparatus to encode and store time-windows for expected visitors and generate optical credentials as visitor indicia and policies to greet, transform messages, and determine various access to visitors, both expected or unexpected. A video doorbell component of the system triggers on image or audio capture, transforms and verifies optically encoded credentials and actuates a physical access control actuator, triggers a visitor filtration apparatus, or relays images and audio with an interview panel. The optical credential is transmitted electronically to an expected visitor and may be printed or displayed from an electronic media. Policies enable recognition of biometrically enhanced images of faces or faces with uniform hats such as emergency services agents. Messages are stored for replay or transmitted immediately.

### CROSS-REFERENCE TO RELATED APPLICATIONS

None.

### STATEMENT REGARDING FEDERALLY SPONSORED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISK OR AS A TEXT FILE VIA THE OFFICE ELECTRONIC FILING SYSTEM (EFS-WEB)

Not Applicable.

### STATEMENT REGARDING PRIOR DISCLOSURES BY THE INVENTOR OR A JOINT INVENTOR

Not Applicable.

### BACKGROUND OF THE INVENTION

### Technical Field

The disclosure relates to video security systems and physical access control.

### Background

As is known wireless security cameras are combined with bidirectional voice telephony.

As is known, voicemail, Short Messaging Service, and email enable time-shifting electronic messaging.

What is needed is a solution for the problem of physical key exchange for occasional visitors and improvements in interviewing expected and unexpected visitors.

### SUMMARY OF INVENTION

A video doorbell apparatus and electronic access control system operates by determining a date-time when a video doorbell is actuated by a recognizable extemporaneous caller; a scheduled visitor/services provider; or an unknown solicitor/stranger. In the latter case, providing an outgoing message, and from a date-time policy at least one of the following, recording a message for delayed playback, connecting the interview panel to the video doorbell immediately, relaying the recorded message on schedule or request from the interview panel, and transmitting a notification, wherein an unknown solicitor/stranger is any party which neither a recognizable extemporaneous caller nor a scheduled visitor/services provider.

This includes receiving a credential presented to the video doorbell; verifying the credential is valid for the location of the video doorbell and the date-time is within a valid range; transmitting a notification; and playing an outgoing message/instruction.

The method for determining a data-time when a video doorbell is actuated by a scheduled visitor/services provider includes: generating a credential for a visitor/services provider to access a portal; determining a range of date-time for validity of the credential; distributing the credential to a communication device of the visitor/service provider; transforming the credential and the range of valid date-time into a first encrypted code; distributing the first encrypted code to the portal.

A method at the video doorbell, includes receiving the first encrypted code; receiving the credential from the communication device of the visitor/service provider at a date-time, transforming the date-time of reception and the credential into a second encrypted code, and matching the first encrypted code with the second encrypted code.

The method for responding to a category of recognizable extemporaneous caller includes selecting among a store of policies for each category and date-time, presenting an outgoing message or greeting, communicatively coupling the video doorbell to one of an interview panel and a message store according to the selected policy, and responding to access control instructions at the interview panel.

A method for determining that a video doorbell is actuated by

a Recognizable extemporaneous caller includes: determining a match with biometric indicia in a store of friends/family/neighbors; determining a match with image indicia of uniforms and badges of identification; and determining a match with stored shipping waybills and product barcodes.

A system enables a visitor filtration apparatus to encode and store time-windows for expected visitors and generate time limited optical credentials as visitor indicia and policies to greet, transform messages from, and determine various access to visitors both expected or unexpected.

The system includes at least a video doorbell (videoorbell) having electronic and audio communication circuits, a camera, and a processor. The system couples to an interview panel by which a visitee stores outgoing messages, date-time windows, access policies, and visitor indicia and attends to incoming messages in delayed or real time.

A secure optically encoded credential such as a QR or a bar code is transmitted to an expected visitor with its date-time validity. A transformed secure optically encoded credential is stored in a visitor filtration apparatus or in a videoorbell.

Various policies provide for physical access control or electronic access by direct coupling or stored messages. Policies operate on date-time of the visit, and visitor indicia which includes faces, voices, badges, uniforms, package delivery waybills, and combinations thereof.

A video doorbell component of the system triggers on image or audio capture, transforms and verifies optically encoded credentials and actuates a physical access control actuator, a visitor filtration apparatus, or relays images and audio with an interview panel. The optical credential, e.g. QR code or bar code, is transmitted electronically to an expected visitor and may be printed or displayed from an electronic media. Policies enable recognition of biometrically enhanced images of faces or faces with uniform hats such as emergency services agents. Messages are stored for replay or transmitted immediately.

The system may actuate a physical access control apparatus or couple the video doorbell directly to an interview panel of the visitee or of an intermediary, or present greetings or instructions and take audio-visual messages. Voice to text circuits may override stored policies for emergency keywords, e.g. “Fire.”

In an embodiment, the system includes a visitor filtration apparatus performing instructions to store outgoing and incoming messages, secure optically encoded credentials, date-time policies and visitor indicia for individuals or for classes such as police, fire, postal employees, delivery agents, utility workers, and complete strangers (none of the above).

### BRIEF DESCRIPTION OF DRAWINGS

The foregoing and other objects, aspects, features, and advantages of the disclosure will become more apparent and better understood by referring to the following description taken in conjunction with the accompanying drawings, in which:

FIG. 1 is a block diagram of a system having a video doorbell, coupled to at least one interview panel, and in an embodiment, coupled to a visitor filtration apparatus.

FIG. 2 is a flowchart of a method of operation for a video doorbell.

FIG. 3 is a flowchart of various non-limiting embodiments of methods for operation of a visitor filtration apparatus communicatively coupled to a video doorbell and to an interview panel

FIG. 4 is a block diagram of a first visitor filtration apparatus component of the invention.

FIG. 5 is a block diagram of embodiments of a visitor filtration apparatus.

FIG. 6 is a block diagram of a processor suitable for performance of the method according to executable instructions stored in non-transient computer-readable media.

### DETAILED DESCRIPTION OF INVENTION

The video doorbell has three general modes of operation. It may generally present greetings to a visitor and receive messages to be stored and forwarded to the visitee. Under certain combinations of date-time and visitor indicia, it may directly couple to an interview panel of the visitee or his intermediary agent or representative. When expected visitors present an optically encoded credential such as bar codes or QR codes, other policies are triggered for physical access or electronic access. The policies may be overridden by combinations of visitor indicia and key words converted from speech. Non-limiting examples of visitor indicia include but are not limited to voice biometrics, and facial biometrics of family, uniform hats of sworn emergency service personnel, package and shipping waybills of delivery services. Stored greetings may include further instructions according to the visitor indicia presented.

A method embodiment of the invention is for operation of a video doorbell apparatus and electronic access control system by: determining a date-time when a video doorbell is actuated by a recognizable extemporaneous caller; determining a date-time when a video doorbell is actuated by a scheduled visitor/services provider; or, determining a date-time when a video doorbell is actuated by an unknown solicitor/stranger, defaulting upon the latter condition to, providing an outgoing message, and from a date-time policy exemplary further steps including but not limited to, recording a message for delayed playback, connecting the interview panel to the video doorbell immediately, relaying the recorded message on schedule or request from the interview panel, and transmitting a notification perhaps to a security service, a relative, a neighbor, or a caregiver.

Under certain conditions and policies, the further method includes receiving a credential presented to the video doorbell; verifying the credential is valid for the location of the video doorbell and the date-time is within a valid range; transmitting a notification; and playing an outgoing message/instruction.

An exemplary non-limiting process for determining when a video doorbell is actuated by a scheduled visitor/services provider includes generating a credential for a visitor/services provider to access a portal; determining a range of date-time for validity of the credential; distributing the credential to a communication device of the visitor/service provider; transforming the credential and the range of valid date-time into a first encrypted code; and distributing the first encrypted code to the portal.

At the video doorbell, one exemplary method includes receiving the first encrypted code; receiving the credential from the communication device of the visitor/service provider at a date-time, transforming the date-time of reception and the credential into a second encrypted code, and matching the first encrypted code with the second encrypted code.

Other method steps include, under certain conditions such as date-time, stored instructions, verification of the visitor, recording an image from the video doorbell and actuating a physical access control apparatus such as opening a door, lift, delivery chute, or gate.

The method of operation also includes: receiving an image from the video doorbell; determining a category of recognizable extemporaneous caller, selecting among a store of policies for each category and date-time, presenting an outgoing message or greeting, communicatively coupling the video doorbell to one of an interview panel and a message store according to the selected policy, and responding to access control instructions at the interview panel.

The method for determining when a video doorbell is actuated by a recognizable extemporaneous caller includes: determining a match with biometric indicia in a store of friends/family/neighbors; determining a match with image indicia of uniforms and badges of identification; and

determining a match with stored shipping waybills and product barcodes.

In an embodiment, the process further includes: selecting among a store of ringtones based on the identity of a category or individual in the store; communicatively coupling the video doorbell to the interview panel of a legal representative; and actuating a physical access control portal according to the instruction at the interview panel.

In an embodiment, the video doorbell hashes the optically encoded credential with one or more most significant bits of date-time and attempts to match the resulting hash with a stored transformation of the optically encoded credential sent to the visitor. Upon success or failure of matching, doors may be opened or not, messages can be presented to the visitor, direct communication with a selected interview panel can be coupled, or a message may be recorded for immediate or delayed delivery to the visitee.

Referring now to the exemplary figures and other non-limiting embodiments provided for clarification of aspects of the invention without constraining the breadth of the inventive concepts:

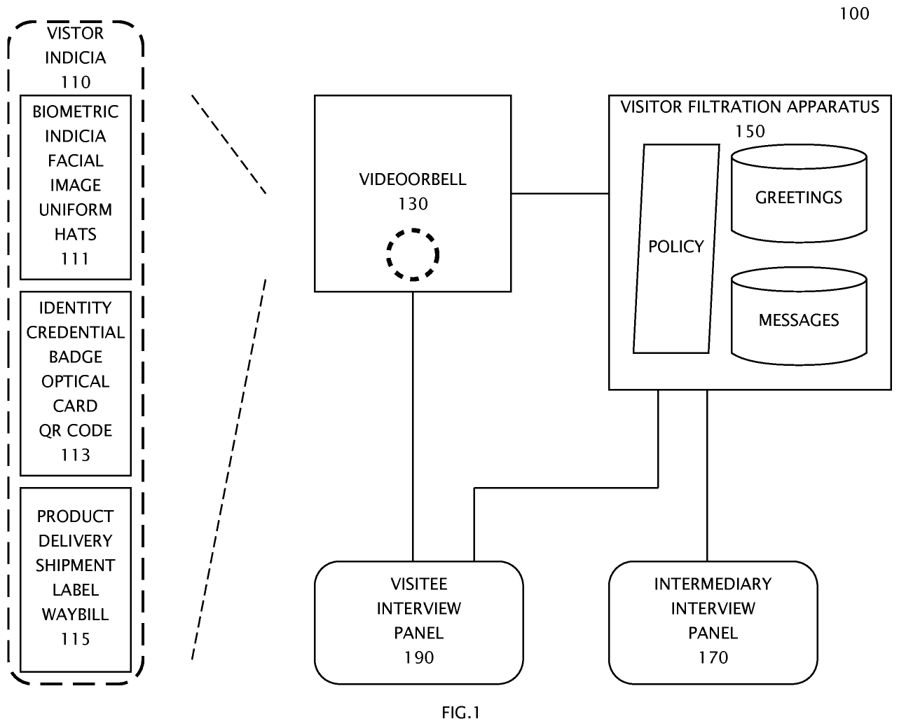

FIG. 1 is a block diagram of a system having a video doorbell (videoorbell) 130, coupled to a visitor filtration apparatus 150. Both the videoobell and the visitor filtration apparatus enable filtered communication with a selected visitee interview panel 190 or to an intermediary interview panel 170 based on date-time, policies, and visitor indicia.

Exemplary visitors 110 actuate the videoorbell 130 by triggering an audio or video sensor and presenting an optically encoded credential or biometric such as a face, voice, or a government agency credential such as an official warrant card or badge, or a package code, or a service provider identification. A hash or other transformation of date-time and an optically encoded credential is compared with a stored transformation of an optically encoded credential for an expected visitor to trigger a policy for physical access or electronic access. When no matching transformation is found, for example an unexpected visitor, visitor indicia is relayed to a visitor filtration apparatus 150. The visitor filtration apparatus 150 may present directions or greetings, store and forward messages, and apply policies based on stored identities and date-time of visit to connect in timeshifted or real-time to an intermediary interview panel 170 or to a visitee interview panel 190. Expected or high priority visitor indicia may be downloaded to the videoorbell for immediate and direct connection to a selected panel.

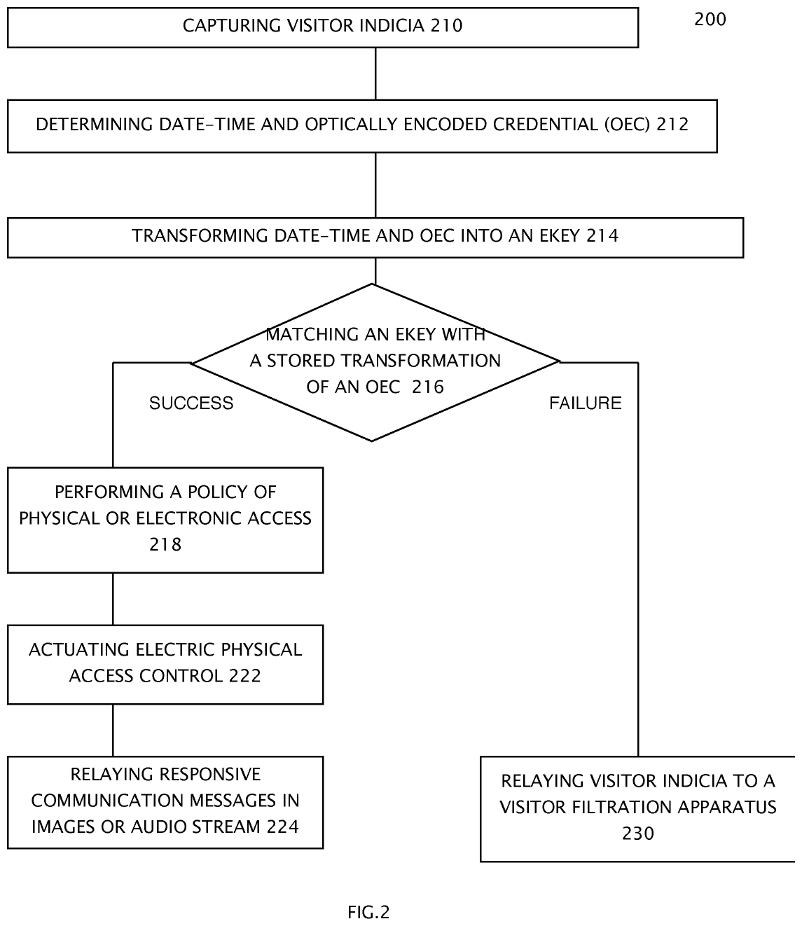

FIG. 2 is a flowchart of a first method 200 of operation for a videoorbell, upon activation, capturing visitor indicia 210 including at least one of an audio stream of a visitor, a still image of a visitor, a video stream of a visitor, and a credential encoded in computer-readable optical imagery; determining date-time and optically encoded credential 212; transforming said date-time and optically encoded credential into ekey 214; matching said ekey with a stored transformation of an optically encoded credential 216; performing upon successful matching, a policy of physical or electronic access enablement 218; and upon failed matching, relaying said visitor indicia to a visitor filtering apparatus 230; wherein said policy of access enablement includes but is not limited to actuating electric physical access controls 222 and relaying (receiving, transmitting, transforming, and presenting) responsive communication messages in images or audio stream 224.

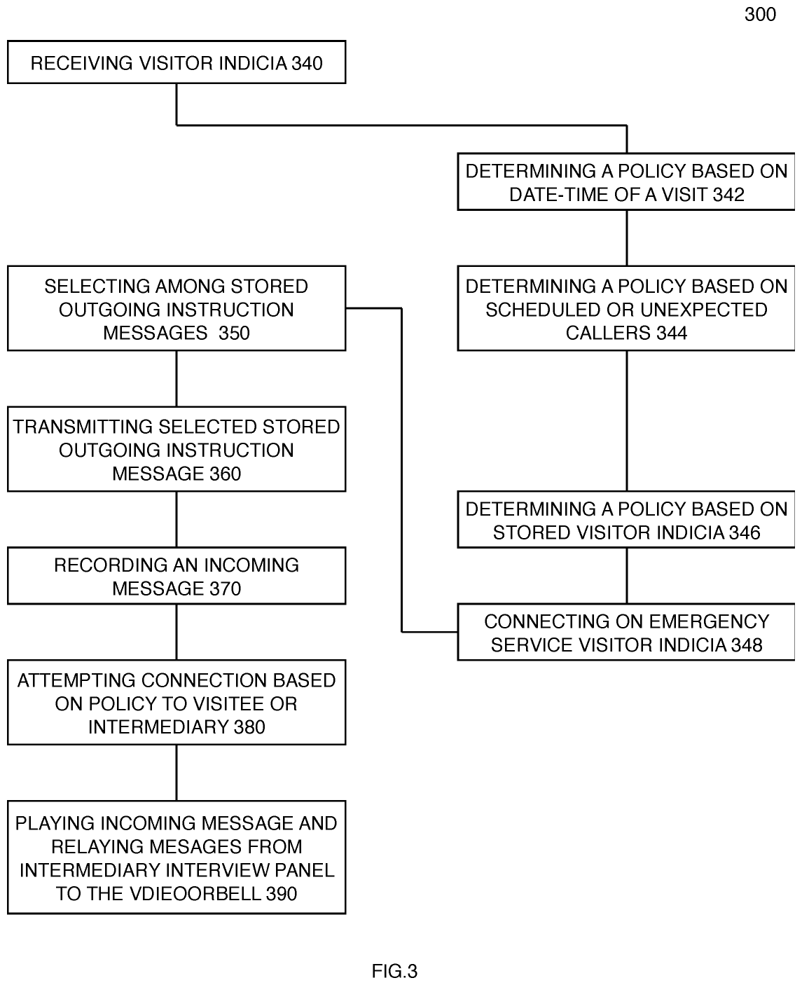

FIG. 3 is a flowchart 300 of various non-limiting embodiments of methods for operation of a visitor filtration apparatus communicatively coupled to a video doorbell and to an interview panel, receiving visitor indicia 340, determining a policy based on date-time of a visit 342, determining a policy based on scheduled or unexpected callers 344, determining a policy based on stored visitor indicia such as faces, badges, packages, service provider identity documentation 346; connecting immediately on the condition of emergency service visitor indicia 348; selecting among a plurality of stored outgoing instruction messages 350, transmitting the selected stored outgoing instruction message 360, recording an incoming message 370, and attempting connection based on date-time policy to one of a visitee interview panel and an intermediary interview panel such as a legal service provider 380; and upon successful connection playing the incoming message and relaying responsive communication messages from the intermediary interview panel to the videoorbell 390.

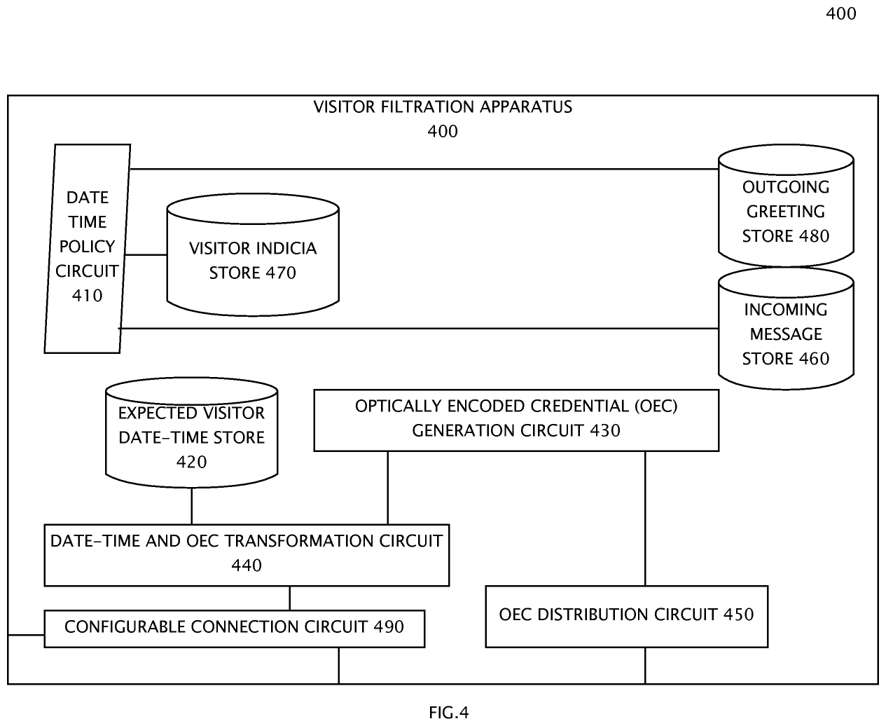

FIG. 4 is a block diagram of a first apparatus embodiment of a visitor filtration apparatus 400 the apparatus comprising: a date-time policy circuit 410; an expected visitor date-time appointment range store 420; an optically encoded credential generation circuit 430; a date-time and optically encoded credential transformation circuit 440; an optically encoded credential distribution circuit 450; an incoming message store 460; a visitor indicia store 470; an outgoing greeting store 480; and a configurable connection circuit 490 which determines if and when a visitor or message is communicatively coupled to a selected visitee interview panel or intermediary interview panel. Non-limiting examples of an optically encoded credential distribution circuit include a radio, a cellular baseband processor, a Simple Mail Transfer Protocol email server, a Short Message Service client, and a Portable Document Format image fax server.

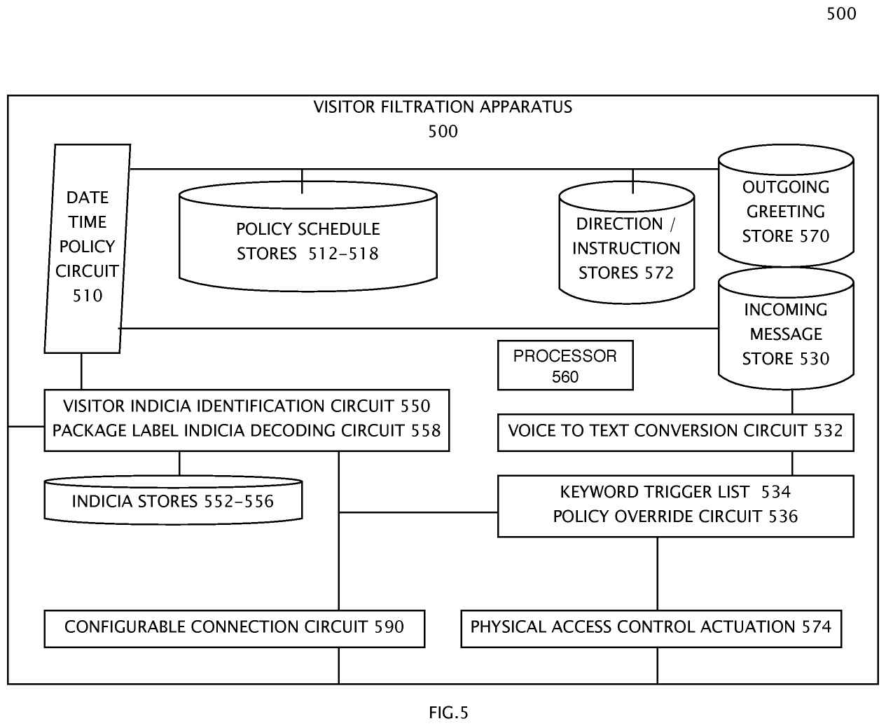

FIG. 5 is a block diagram of embodiments of a visitor filtration apparatus 500 which includes circuits distributable among displays, videoorbells, custom or programmable chips, and processors performing instructions encoded and readable from non-transient media, embodiments of the apparatus comprising at least one of: a date-time policy circuit 510; a policy store of when visitors of certain types may be connected 512; a policy store of which outgoing greetings are played by visitor indicia 514; a policy store of when incoming messages are relayed to the visitee interview panel 516; a schedule store of when certain visitors are expected 518; an incoming message store 530; a voice to text conversion circuit 532; a keyword trigger list 534; a policy override trigger responsive to keywords 536; a visitor indicia identification circuit 550; a government agency identity indicia store 552; a service identity indicia store 554; a personal visitor biometric indicia store 556; a package label indicia decoding circuit 558; an outgoing greeting store 570; a selectable direction or instruction message store 572; a physical access control actuation circuit 574; and a configurable connection circuit 590 which determines if and when a visitor or message is communicatively coupled to a selected visitee interview panel or to an intermediary interview panel; said circuits and stores mutually coupled communicatively with a processor 560. Non-limiting examples of an intermediary include a trustee, a parent, a conservator, an adult child, a legal services provider, an attorney, and an executive assistant. In exemplary embodiments, a keyword trigger list includes audio files for “Fire”, “Police”, “Help”, “Lost Key”, and “family's secret word is . . . ”.

Other embodiments of the invention include a system comprising a video doorbell (videoorbell); an intercommunication portal (IP); and a visitor filtration apparatus coupling said IP and said videoorbell, whereby a visitee operator may anticipate a visitor with certain date-time schedule and visitor indicia, store a greeting to be presented by the videoorbell upon matching said visitor indicia within said date-time schedule, and relay a message from videoorbell to intercommunication portal following a policy stored by the visitee operator.

In an embodiment, a policy stored by the visitee operator causes immediate real-time connection between IP and videoorbell when the visitor indicia is one of a face of close family members, and a face with uniform hat of emergency responders.

In an embodiment, a policy stored by the visitee operator causes presentation of an outgoing greeting and storing an incoming message when the visitor indicia is one of face with uniform hat of delivery service, and face with uniform hat of government/utility representative.

In an embodiment, a visitor indicia is a shipment tracking document.

In an embodiment, certain visitor indicia causes one of recording, transforming, storing, and forwarding a message to a visitee interview panel, and direct real-time connection to a legal services intermediary interview panel.

In an embodiment, said visitor filtration apparatus comprises a processor coupled to a policy store, a visitor indicia store, an outgoing greeting store, an incoming message store, and a connection circuit to couple to the videoorbell, the visitee interview panel, the legal services intermediary interview panel, the greeting store, and the message store.

In an embodiment, an interview panel is one of a computer workstation, a mobile device, a cellular telephone, and a vehicle dashboard.

### Conclusion

The present invention can be easily distinguished from simple voice mail or email system for presenting and receiving messages or video telephony. Stored policies enable time-shifting of physical or electronic access and limiting date-time ranges for each policy. Credentials may be cancelled unlike physical key lock boxes.

The present invention solves the long sought key exchange problem. A voicemail/cellphone cannot solve a key exchange problem. It avoids needing a physical key (vulnerable to duplication) to be exchanged. The invention creates temporary & conditional keys.

The invention generates a new type of key that does not need physical exchange. Non-limiting examples include a physical optical key (printed QR-code) or digital image key (QR-code on mobile phone screen) which is temporary & conditional. The key can be invalidated remotely.

### Exemplary Use Cases:

First. An apartment resident uses a cleaning service once a week. The cleaner person needs to enter the apartment to clean it. She/he needs keys. The apartment resident does not want to give key to his/her cleaner because keys can be copied, misplaced, or stolen.

Our system enables a visitee to generate a temporary key (QR-Code) (which is only valid for a period of time and in specific conditions) to show to video door bell. QR-code is captured by the video door bell. The system recognizes the QR code and decides to actuate the door. The digital lock in the door (which is managed by our access control system) opens. So, we don't bother the home owner (the apartment resident) in order to open the door. He might be in a meeting etc.

Temporary key can be valid for a period of time based on QR-code, faceId, or combination of them. Features: no disturbing the resident.

Second. A home owner wants to rent his apartment via AirBnB, social media, home rental web sites, etc. He needs to give the keys for a specific period of time (for a couple of days, etc) to a tenant. He does not want to give physical keys to tenant, because the keys could be copied and he would need to spend time to meet him. Our invention solves this issue by temporary & conditional digital keys. The tenant does not need a cellphone. He just shows printed QR-code to the videodoorbell in order to enter the home. A start and end date-time range validates the QR-code.

Third. Certain family members may need access in an emergency or unexpected time range. Stored visitor indicia such as face or voice biometrics and keywords using speech to text can override policies of when to directly connect to an interview panel or actuate physical access control, yet avoid nuisance doorbell ringing by mischievous, disoriented or hostile trespassers.

As is known, circuits disclosed above may be embodied by programmable logic, field programmable gate arrays, mask programmable gate arrays, standard cells, and computing devices limited by methods stored as instructions in non-transitory media.

Generally a computing devices 600 can be any workstation, desktop computer, laptop or notebook computer, server, portable computer, mobile telephone or other portable telecommunication device, media playing device, a gaming system, mobile computing device, or any other type and/or form of computing, telecommunications or media device that is capable of communicating on any type and form of network and that has sufficient processor power and memory capacity to perform the operations described herein. A computing device may execute, operate or otherwise provide an application, which can be any type and/or form of software, program, or executable instructions, including, without limitation, any type and/or form of web browser, web-based client, client-server application, an ActiveX control, or a Java applet, or any other type and/or form of executable instructions capable of executing on a computing device.

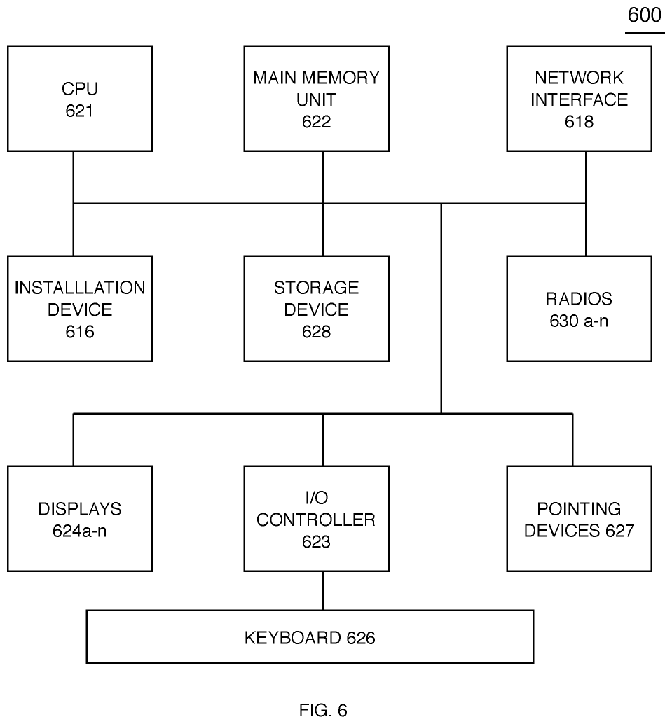

FIG. 6 depicts block diagrams of a computing device 600 useful for practicing an embodiment of the invention. As shown in FIG. 6, each computing device 600 includes a central processing unit 621, and a main memory unit 622. A computing device 600 may include a storage device 628, an installation device 616, a network interface 618, an I/O controller 623, display devices 624a-n, a keyboard 626, a pointing device 627, such as a mouse or touchscreen, and one or more other I/O devices 630a-n such as baseband processors, Bluetooth, GPS, and Wi-Fi radios. The storage device 628 may include, without limitation, an operating system and software.

The central processing unit 621 is any logic circuitry that responds to and processes instructions fetched from the main memory unit 622. In many embodiments, the central processing unit 621 is provided by a microprocessor unit, such as: those manufactured under license from ARM; those manufactured under license from Qualcomm; those manufactured by Intel Corporation of Santa Clara, Calif.; those manufactured by International Business Machines of Armonk, N.Y.; or those manufactured by Advanced Micro Devices of Sunnyvale, Calif. The computing device 600 may be based on any of these processors, or any other processor capable of operating as described herein.

Main memory unit 622 may be one or more memory chips capable of storing data and allowing any storage location to be directly accessed by the microprocessor 621. The main memory 622 may be based on any available memory chips capable of operating as described herein.

Furthermore, the computing device 600 may include a network interface 618 to interface to a network through a variety of connections including, but not limited to, standard telephone lines, LAN or WAN links (e.g., 802.11, T1, T3, 56 kb, X.25, SNA, DECNET), broadband connections (e.g., ISDN, Frame Relay, ATM, Gigabit Ethernet, Ethernet-over-SONET), wireless connections, or some combination of any or all of the above. Connections can be established using a variety of communication protocols (e.g., TCP/IP, IPX, SPX, NetBIOS, Ethernet, ARCNET, SONET, SDH, Fiber Distributed Data Interface (FDDI), RS232, IEEE 802.11, IEEE 802.11a, IEEE 802.11b, IEEE 802.11g, IEEE 802.11n, CDMA, GSM, WiMax and direct asynchronous connections). In one embodiment, the computing device 600 communicates with other computing devices 600 via any type and/or form of gateway or tunneling protocol such as Secure Socket Layer (SSL) or Transport Layer Security (TLS). The network interface 118 may comprise a built-in network adapter, network interface card, PCMCIA network card, card bus network adapter, wireless network adapter, USB network adapter, modem or any other device suitable for interfacing the computing device 600 to any type of network capable of communication and performing the operations described herein.

A computing device 600 of the sort depicted in FIG.6 typically operates under the control of operating systems, which control scheduling of tasks and access to system resources. The computing device 600 can be running any operating system such as any of the versions of the MICROSOFT WINDOWS operating systems, the different releases of the Unix and Linux operating systems, any version of the MAC OS for Macintosh computers, any embedded operating system, any real-time operating system, any open source operating system, any proprietary operating system, any operating systems for mobile computing devices, or any other operating system capable of running on the computing device and performing the operations described herein. Typical operating systems include, but are not limited to: WINDOWS 10, manufactured by Microsoft Corporation of Redmond, Wash.; MAC OS and iOS, manufactured by Apple Inc., of Cupertino, Calif.; or any type and/or form of a Unix operating system.

In some embodiments, the computing device 600 may have different processors, operating systems, and input devices consistent with the device. In other embodiments, the computing device 600 is a mobile device, such as a JAVA-enabled cellular telephone or personal digital assistant (PDA). The computing device 600 may be a mobile device such as those manufactured, by way of example and without limitation, Kyocera of Kyoto, Japan; Samsung Electronics Co., Ltd., of Seoul, Korea; or Alphabet of Mountain View CA. In yet other embodiments, the computing device 600 is a smart phone, Pocket PC Phone, or other portable mobile device supporting Microsoft Windows Mobile Software.

In some embodiments, the computing device 600 comprises a combination of devices, such as a mobile phone combined with a digital audio player or portable media player. In another of these embodiments, the computing device 600 is device in the iPhone smartphone line of devices, manufactured by Apple Inc., of Cupertino, Calif. In still another of these embodiments, the computing device 600 is a device executing the Android open source mobile phone platform distributed by the Open Handset Alliance; for example, the device 600 may be a device such as those provided by Samsung Electronics of Seoul, Korea, or HTC Headquarters of Taiwan, R.O.C. In other embodiments, the computing device 600 is a tablet device such as, for example and without limitation, the iPad line of devices, manufactured by Apple Inc.; the Galaxy line of devices, manufactured by Samsung; and the Kindle manufactured by Amazon, Inc. of Seattle, Wash.

As is known, circuits include gate arrays, programmable logic, and processors executing instructions stored in non-transitory media provide means for scheduling, cancelling, transmitting, editing, entering text and data, displaying and receiving selections among displayed indicia, and transforming stored files into displayable images and receiving from keyboards, touchpads, touchscreens, pointing devices, and keyboards, indications of acceptance, rejection, or selection.

It should be understood that the systems described above may provide multiple ones of any or each of those components and these components may be provided on either a standalone machine or, in some embodiments, on multiple machines in a distributed system. The phrases in one embodiment’, in another embodiment’, and the like, generally mean the particular feature, structure, step, or characteristic following the phrase is included in at least one embodiment of the present disclosure and may be included in more than one embodiment of the present disclosure. However, such phrases do not necessarily refer to the same embodiment.

The systems and methods described above may be implemented as a method, apparatus or article of manufacture using programming and/or engineering techniques to produce software, firmware, hardware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be PHP, PROLOG, PERL, C, C++, C#, JAVA, or any compiled or interpreted programming language.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of computer-readable devices, firmware, programmable logic, hardware (e.g., integrated circuit chip, electronic devices, a computer-readable non-volatile storage unit, non-volatile memory, such as semiconductor memory devices, including EPROM, EEPROM, and flash memory devices; magnetic disks such as internal hard disks and removable disks; magneto-optical disks; and nanostructured optical data stores. Any of the foregoing may be supplemented by, or incorporated in, specially-designed ASICs (application-specific integrated circuits) or FPGAs (Field-Programmable Gate Arrays). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium. A computer may also receive programs and data from a second computer providing access to the programs via a network transmission line, wireless transmission media, signals propagating through space, radio waves, infrared signals, etc.

Having described certain embodiments of methods and systems for video surveillance, it will now become apparent to one of skill in the art that other embodiments incorporating the concepts of the disclosure may be used. Therefore, the disclosure should not be limited to certain embodiments, but rather should be limited only by the spirit and scope of the following claims.

We claim:

1. A method for operation of a video doorbell (videoorbell) apparatus and electronic access control system comprising:
determining a date-time when a video doorbell is actuated by a recognizable extemporaneous caller (REC);
determining a date-time when a video doorbell is actuated by a scheduled visitor/services provider (SVSP); and,
determining a date-time when a video doorbell is actuated by an unknown solicitor/stranger (USS), upon which condition, providing an outgoing message, and from a date-time policy at least one of the following, recording a message for delayed playback, connecting the interview panel to the video doorbell immediately, relaying the recorded message on schedule or request from the interview panel, and transmitting a notification, wherein an unknown solicitor/stranger is any party which neither a recognizable extemporaneous caller nor a scheduled visitor/services provider.

2. The method of claim 1 further comprising: receiving a credential presented to the video doorbell;
verifying the credential is valid for the location of the video doorbell and the date-time is within a valid range;
transmitting a notification; and
playing an outgoing message/instruction;
wherein, determining a data-time when a video doorbell is actuated by a scheduled visitor/services provider comprises:
generating a credential for a (SVSP) to access a portal;
determining a range of date-time for validity of the SVSP credential;
distributing the SVSP credential to a communication device of the visitor/service provider;
transforming the SVSP credential and the range of valid date-time into a first encrypted code;
distributing the first encrypted code to the portal;
at the video doorbell, receiving the first encrypted code;
receiving the SVSP credential from the communication device of the SVSP at a date-time, transforming the date-time of reception and the SVSP credential into a second encrypted code, and matching the first encrypted code with the second encrypted code.

3. The method of claim 2 further comprising: recording an image from the video doorbell and actuating a physical access control apparatus.

4. The method of claim 1 further comprising:
receiving an image from the video doorbell;
determining a category of recognizable extemporaneous caller (REC);
selecting among a store of policies for each category and date-time;
presenting an outgoing message or greeting;
communicatively coupling the video doorbell to one of an interview panel and a message store according to the selected policy; and
responding to access control instructions at the interview panel.

5. The method of claim 4 wherein, determining a date-time when a video doorbell is actuated by a recognizable extemporaneous caller (REC) comprises:
determining a match with biometric indicia in a store of friends/family/neighbors.

6. The method of claim 4 wherein, determining a date-time when a video doorbell is actuated by a recognizable extemporaneous caller comprises:
determining a match with image indicia of uniforms and badges of identification.

7. The method of claim 4 wherein, determining a date-time when a video doorbell is actuated by a recognizable extemporaneous caller comprises:
determining a match with stored shipping waybills and product barcodes.

8. The method of claim 4 further comprising:
selecting among a store of ringtones based on the identity of a category or individual in the store.

9. The method of claim 4 further comprising:
communicatively coupling the video doorbell to the interview panel of a legal representative.

10. The method of claim 4 further comprising:
actuating a physical access control portal according to an instruction at the interview panel.

11. A method of operation for a video doorbell (Videoorbell) apparatus comprising the processes:
capturing an audio-video stream;
transforming date-time of capture and an optically encoded credential (OEC) within said audio-video stream into a hash;
matching a stored transformation of an OEC with said hash; and
performing an access policy according to the condition of one of success of said matching, and failure of said matching.

12. A video doorbell apparatus comprises:
a store for at least one transformed optically encoded credential;
a date-time circuit;
an audio-video capture device;
a processor; and
at least one communication circuit communicatively coupled to a visitor filtration apparatus.

13. The visitor filtration apparatus of claim 12 further coupled to a communication device of a scheduled visitor/services provider.

14. A method of operation for a visitor filtration apparatus comprising the processes:
receiving from a visitee interface panel a date-time range and identity for an expected visitor;
generating an optically encoded credential (OEC) for the expected visitor;
transmitting said OEC and date-time range to the expected visitor;
storing a transformed OEC and date-time range into a video doorbell;
storing visitor indicia and access policies for particular visitors and classes of visitors;
storing and relaying incoming messages to a visitee interface panel according to a policy;
interconnecting a visitee interface panel to a video doorbell according to a policy;
receiving visitor indicia from a video doorbell; and
performing an access policy upon matching visitor indicia with a one of visitor indicia in a store.

15. The method of operation of claim 14 further comprising:
overriding an access policy upon determining an incoming message contains an emergency trigger.
